(19) United States
(12) Patent Application Publication
(10) Pub. No.: US 2007/0269173 A1
(43) Pub. Date: Nov. 22, 2007

(54) MULTIPLE NUMERICAL APERTURE FIBER OPTICS ARRAY

(76) Inventor: Chun I. Lu, Taipei (TW)

Correspondence Address: LEONG C LEI, PMB # 1008, 1867 YGNACIO VALLEY ROAD, WALNUT CREEK, CA, 94598, US

(21) Appl. No.: 11/383,757

(22) Filed: May 17, 2006

(51) Int. Cl. G02B 6/06; G02B 6/04

(52) U.S. Cl. 385/117; 385/115; 385/116

(57) ABSTRACT

A multiple numerical aperture (MNA) fiber optics array is provided, which contains multiple fibers having two or more different numerical apertures arranged and fused together. Each fiber has a transparent core wrapped inside a cladding having a higher refractive index than that of the core. Therefore, by projecting light beams into the fibers of different numerical apertures from one end, the light beams emitted out of the other end of the fibers have different ranges of coverage. The MNA fiber optics array can be used in its rod form, or after the rod is sliced cross-sectionally. For the latter, the sliced MNA fiber optics array is further fabricated into plano-convex, concave lenses by grinding and polishing, or meniscus lenses by molding.

### BACKGROUND OF THE INVENTION

(a) Technical Field of the Invention

The present invention generally relates to fused fiber optics arrays, and more particularly to a fused fiber optics array containing multiple fibers of different numerical apertures.

(b) Description of the Prior Art

A conventional fiber 50, as shown in FIG. 15, mainly contains a core 51 in the center surrounded by a cladding 52, both of which are made of glass, plastic, or fuse silica. The cladding 52 has a lower refractive index than that of the core 51. As such, a light wave travels through the core 51 of the fiber 50 by constantly bouncing from the cladding 52 having higher refractive index through internal total reflections, as illustrated in FIG. 16.

Because the cladding does not absorb any light from the core, a light signal can travel great distances. However, some of the light signal degrades along the way, mostly due to the absorption, diffraction, or other non-linear optical effects from the impurities contained in the core. Therefore, a so-called hollow-core fiber has been proposed, in which the fiber has a hollow center surrounded by alternating layers of glass having high refractive index and polymer having low refractive index. Tested with CO₂ laser of 10.6˜μm wavelength, the hollow-core has an attenuation rate as low as 1.0 dB, which means the light signal's energy loss is several magnitudes less than that of conventional fibers.

In addition to being applied in telecommunications, fibers are also commonly applied for illumination purposes. One such example is the driller used by the dentists. Conventionally, a dentist relies on an external light source for lighting into a patient's mouth in conducting treatments, which is quite inconvenient and even dangerous sometimes. Therefore, as shown in FIG. 9, a conventional fiber or fiber optics array (i.e., a bundle of fibers fused together) 50 is integrated into a driller 30 so as to guide and project the light (R) out near the drill of the driller 30 for illumination inside the patient's mouth.

The drillers 30 having integrated fibers or fiber optics arrays 50 are widely popular among dentists. However, the conventional fiber or fiber optics array 50 has a single numerical aperture and therefore can only provide a single range of illumination coverage. When the dentist uses the water with air sprayer for cleaning during the drilling operation, the misty water vapor would seriously impair the output illumination of the fiber or fiber optics array 50. The hollow-core fibers may be quite effective in reducing energy loss of the transmitted light signal, but they suffer the same problem when applied to a driller.

On the other hand, in the field of light emitting diodes (LEDs), a LED chip is usually packaged in a body 40 with glass dome 41 on the top, as shown in FIG. 11, so as to distribute the light from the LED chip (not shown) more widely. However, the adoption of the glass dome 41 inevitably increases the dimension and height of the LED packages. A UK-based company, L₂Optics (see www.12optics.oc.uk), which focuses on the production of lenses for LEDs, has proposed a so-called series lenses. The series lenses alter the angles of light emission by having various cuts and fluctuant ripples along the surface of the lenses so as to achieve different light distribution and brightness enhancement to the LEDs. Despite its effectiveness, a series lens is very difficult to manufacture, requiring very detailed and accurate surface processing which inevitably increases the production cost significantly.

### SUMMARY OF THE INVENTION

The primary purpose of the present invention is to provide a fused fiber optics array so as to obviate the foregoing shortcomings of conventional fibers and lenses. The fused fiber optics array of the present invention is formed by multiple fibers having two or more different numerical apertures arranged and fused together. Each fiber has a transparent core wrapped inside a cladding having a different refractive index than that of the core. Hereinafter, the fiber optics array of the present invention is referred to as MNA (multiple numerical apertures) fiber optics array.

Therefore, by projecting light beams into the fibers of different numerical apertures from one end, the light beams emitted out of the other end of the fibers have different ranges of coverage. In other words, a single fused fiber optics array can deliver different patterns of light coverage. For example, some light beams may be focused to a point while other light beams are diffused to offer larger area of lighting.

The fibers can be arranged in various manners to form an appropriate cross-sectional shape. For example, the bundle of the fibers can be arranged concentrically to have a circular cross-section. Each of the cores can be made of a transparent glass or plastic of different colors. The cross-section of each core can be circular, hexagonal, or any other appropriate shape such as oval.

The MNA fiber optics array can be used in its rod form, or after the rod is sliced cross-sectionally. For the latter, the sliced fiber optics array can be further grinded and polished into a plano-convex or concave lens.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view showing the MNA fiber optics array according to a first embodiment of the present invention.

FIG. 2 is a sectional view showing the MNA fiber optics array of FIG. 1 in front of a light source.

FIG. 3 is a sectional view showing the MNA fiber optics array of FIG. 1 fabricated to form a convex lens to a light source.

FIG. 4 is a sectional view showing the MNA fiber optics array of FIG. 1 fabricated to form a concave lens to a light source.

FIG. 5 is a sectional view showing the MNA fiber optics array according to a second embodiment of the present invention.

FIG. 6 is a sectional view showing the MNA fiber optics array of FIG. 5 in front of a light source.

FIG. 7 is a sectional view showing the MNA fiber optics array of FIG. 5 fabricated to form a convex lens to a light source.

FIG. 8 is a sectional view showing the MNA fiber optics array of FIG. 5 fabricated to form a concave lens to a light source.

FIG. 9 is a schematic view showing a driller used by dentists having a conventional fiber or fiber optics array integrated

FIG. 10 is a schematic view showing a driller used by dentists having an integrated MNA fiber optics array according to the present invention.

FIG. 11 is a side view showing a conventional LED package.

FIG. 12 is a side view showing a MNA fiber optics array according to the present invention applied in a LED package.

FIG. 13 shows the results of the processing steps of FIG. 14.

FIG. 14 is a flow chart showing the processing steps of making a MNA fiber optics array according to the present invention.

FIG. 15 is a perspective view showing a conventional fiber.

FIG. 16 is a schematic sectional view showing the light signal propagation in the conventional fiber of FIG. 15.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a MNA fiber optics array formed by arranging and fusing together multiple fibers. Each fiber contains a transparent core of a specific numerical aperture, which in turn is surrounded by a cladding.

The numerical aperture (NA) of a core is defined by the following equation:

NA≡n₀ sin θ=\sqrt{n₂²−n₁²}

where n₀ is the refractive index of air (which is usually 1), θ is the light acceptance angle (i.e., when the incidence angle of light into the core is less than θ, the light will then undergo internal total reflections and propagate along the core), n₂ is the refractive index of the core, and n₁ is the refractive index of the cladding. According to the equation, cores having different numerical apertures will have different acceptance angles as well, which in turn leads to different emission angles. As such, when multiple cores of two or more numerical apertures are arranged and fused together, various combinations of emission angles can be achieved.

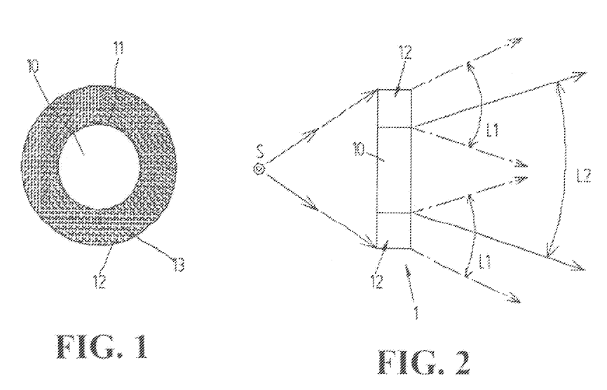

FIG. 1 is a cross-sectional view showing a MNA fiber optics array 1 according to a first embodiment of the present invention. As illustrated, the MNA fiber optics array 1 has a first core 10 having a numerical aperture 0.55 in the center surrounded by a first cladding 11 having a lower refractive index than that of the first core 10. In addition, multiple second cores 12, each having a numerical aperture 0.44 and a hexagonal cross-section, wrapped in respective second claddings 13 whose refractive index is lower than that of the second core 12, are tightly arranged around the first core 10 and the first cladding 11. The assembly is then fused together in vacuum under a high pressure.

When the MNA fiber optics array 1 is put into use, it can be cross-sectionally cut into slices as shown in FIGS. 2, 3, and 4.

As illustrated in FIG. 2, the MNA fiber optics array 1 is positioned in front of a light source (S). The light beams emitted from the light source (S), represented by the arrow heads in the drawing, enter the MNA fiber optics array 1 from one side and exit from the other side. As the first and second cores 10 and 12 have different numerical apertures, the light beams passing through the cores 10 and 12 produces ranges of coverage L2 and L1, respectively. As shown, L2 is wider than L1 as the first core 10 has a larger numerical aperture than that of the second core 12. Therefore, by appropriately arranging cores of different numerical apertures, various patterns of light coverage can be achieved.

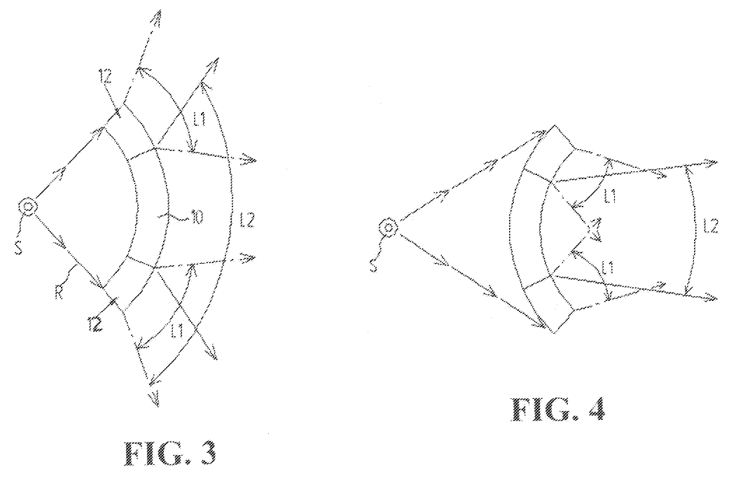

In applications, the MNA fiber optics array 1 can be curved for a pre-determined degree along the axial direction towards to the light source (S) as shown in FIG. 3 or away from the light source (S) as shown in FIG. 4. As illustrated, for the former, the ranges of coverage L1 and L2 are further widened while, for the latter, the ranges of coverage L1 and L2 become more confined.

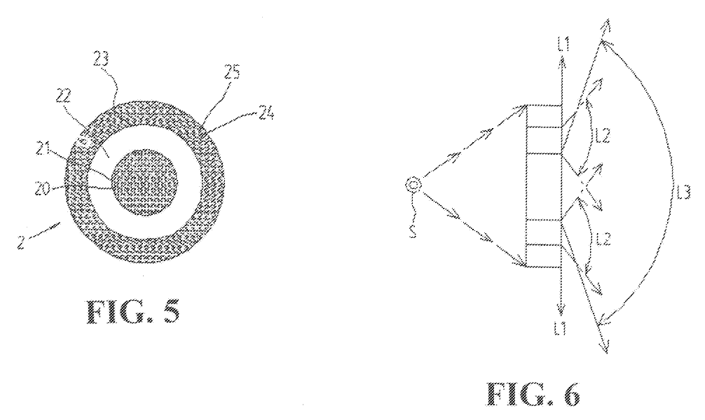

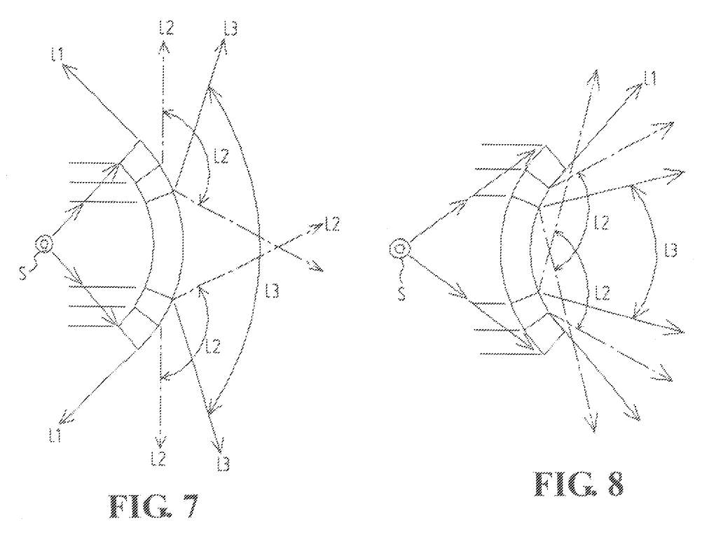

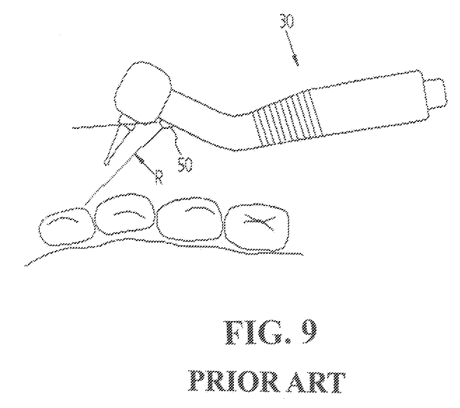

FIG. 5 is a cross-sectional view showing a MNA fiber optics array 2 according to a second embodiment of the present invention. As illustrated, the MNA fiber optics array 2 has multiple third cores 20, each having a numerical aperture 0.65 and a hexagonal cross-section, wrapped in respective third claddings 21, tightly arranged in the center, jointly form a rod of a circular cross-section. Around the “inner core,” the MNA fiber optics array 2 has a concentric, tubular fourth core 22 having a numerical aperture 0.85 which is in turn wrapped in a fourth cladding 23. In addition, multiple fifth cores 24, each having a numerical aperture 0.44 and a hexagonal cross-section, wrapped in respective fifth claddings 25 are tightly arranged around the fourth core 22 and the fourth cladding 23. The bundle is then fused in vacuum under a high pressure. Each of the third, fourth, and fifth claddings 21, 23, and 25 has a different refractive index from that of its respective third, fourth, or fifth core 20, 22, or 24.

Similar to the MNA fiber optics array 1 of the previous embodiment, when the MNA fiber optics array 2 is put into use, it can be cross-sectionally cut into slices as shown in FIG. 6. As the cores 20, 22, and 24 have different numerical apertures, the light beams passing through the cores 20, 22, and 24 produces different ranges of coverage L3, L2, and L1, respectively. In addition, the MNA fiber optics array 2 can be curved for a pre-determined degree along the axial direction towards to the light source (S) as shown in FIB. 7 or away from the light source (S) as shown in FIB. 8. As illustrated, for the former, the ranges of coverage L1, L2, and L3 are further widened while, for the latter, the ranges of coverage L1, L2, and L3 become more confined.

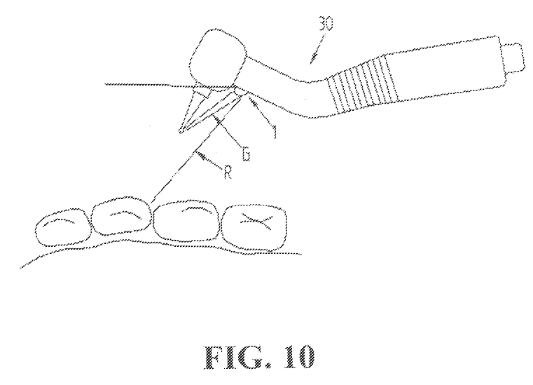

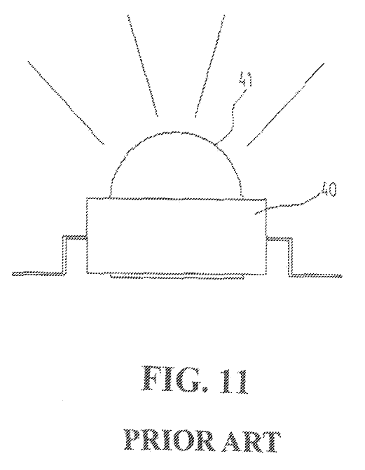

The present invention can resolve various problems encountered in the application of fiber or fiber optics array for light illumination purposes and lenses. As illustrated in FIG. 10, the fiber 1 of the first embodiment is integrated in the driller 30. The first core 10 of the fiber 1 is made of green glass or plastic having a small numerical aperture while the second cores 12 have larger numerical apertures. As such, the green (G) light emitted from the first core 10 is focused to a single point and, therefore, is able to penetrate through the water mist. On the other hand, the light (R) from the second cores 12 is diffused to cover a larger area for general lighting.

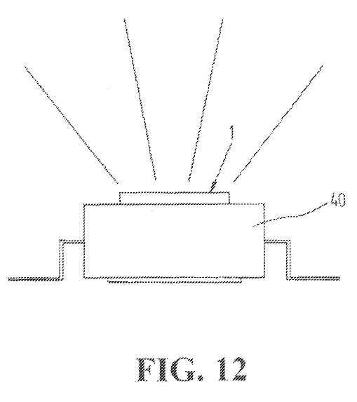

On the other hand, a slice of the MNA fiber optics array 1 of the first embodiment can be used to replace the glass dome 41 of a conventional LED package, as shown in FIG. 12. As such, not only the height of the LED package an be reduced significantly, but also, by varying the arrangement of the cores of different numerical apertures, various light distribution effects for the LED package can be achieved easily.

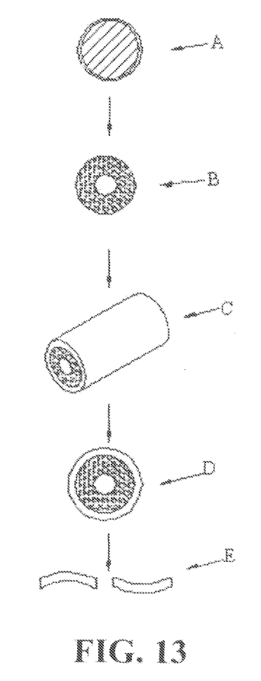

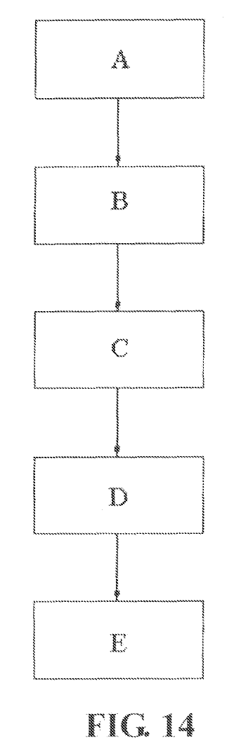

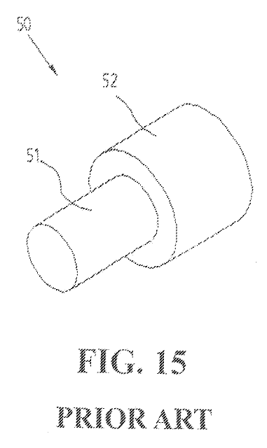

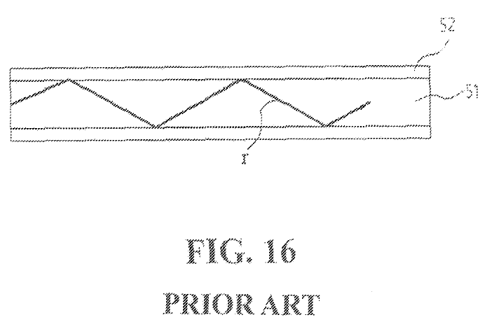

FIGS. 13 and 14 are flow charts showing the result of each processing step in making a MNA fiber optics array according to the present invention. As illustrated, in step A, a number of fibers for the MNA fiber optics array are formed, each by having a glass core of a specific numerical aperture wrapped inside a glass cladding under a high pressure (about 50˜76 cm/Hg) in vacuum.

Then, in step B, the bundle of fibers is arranged according to the optical design of the fiber lens.

Subsequently, in step C, the arranged fibers undergo a high-pressure (about 50˜76 cm/Hg) fusion process at a high temperature about 1,000° C. in vacuum to form the MNA fiber optics array according to the present invention.

If required, the MNA fiber optics array is sliced cross-sectionally using mechanical means in step D.

If required, the sliced MNA fiber optics array is further fabricated into plano-convex, concave lenses by grinding and polishing, or meniscus lenses by molding. The MNA fiber optics array lenses are thereby completed and formed.

Please note that, in addition to having the fibers arranged in a concentric manner, the fibers can also be arranged into a rod having any appropriate cross-section. Each of the cores can be made of a transparent glass or plastic of different colors. The cross-section of each core can be circular, hexagonal, or any other appropriate shape such as oval.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A MNA fiber optics array, comprising:
a plurality of fibers having two or more different numerical apertures arranged and fused together in an appropriate manner, each of said fibers having a transparent core wrapped inside a cladding having a higher refractive index than that of said core.

2. The MNA fiber optics array according to claim 1, wherein said fibers are arranged concentrically.

3. The MNA fiber optics array according to claim 1, wherein each of said cores is made of colored glass.

4. The MNA fiber optics array according to claim 1, wherein each of said cores is made of colored plastic.

5. The MNA fiber optics array according to claim 1, wherein each of said cores has a circular cross-section.

6. The MNA fiber optics array according to claim 1, wherein each of said cores has an oval cross-section.

7. The MNA fiber optics array according to claim 1, wherein each of said cores has a hexagonal or multilateral cross-section.

8. The MNA fiber optics array according to claim 1, wherein said MNA fiber optics array has a first fiber in the center and a plurality of second fibers arranged to wrap around said first fiber; and the numerical apertures of said first fiber and said second fibers are different.

9. The MNA fiber optics array according to claim 1, wherein said MNA fiber optics array has plurality of first fibers arranged in the center, a second fiber wraps around said first fibers concentrically, and a plurality of third fibers arranged to wrap around said second fiber; and the numerical apertures of said first fibers, said second fiber, and said third fibers are different.

10. The MNA fiber optics array according to claim 1, wherein a lens is formed by cross-sectionally slicing said MNA fiber optics array.

11. The MNA fiber optics array according to claim 10, wherein said lens, when placed in front of a light source, is curved toward said light source.

12. The MNA fiber optics array according to claim 10, wherein said lens, when placed in front of a light source, is curved away from said light source.
